(19) United States
(12) Patent Application Publication
(10) Pub. No.: US 2026/0312143 A1
(43) Pub. Date: Oct. 8, 2026

(54) SECONDARY BATTERY AND METHOD OF MANUFACTURING ELECTRODE ASSEMBLY USED FOR SAME

(71) Applicant: Samsung SDI Co., Ltd., Yongin-si (KR)

(72) Inventors: Sumin Lee, Yongin-si (KR); Youngjae Cho, Yongin-si (KR); Soyeon Kim, Yongin-si (KR); Yeonjin Park, Yongin-si (KR); Sungjun Lee, Yongin-si (KR); Jinwook Jung, Yongin-si (KR)

(73) Assignee: Samsung SDI Co., Ltd., Yongin-si (KR)

(21) Appl. No.: 19/456,496

(22) Filed: Jan. 22, 2026

(30) Foreign Application Priority Data
Apr. 8, 2025 (KR) 10-2025-0045741

(51) Int. Cl. H01M 10/0587; C09J 5/00; H01M 4/04; H01M 4/139; H01M 10/0525

(52) U.S. Cl. CPC H01M 10/0587; C09J 5/00; H01M 4/0404; H01M 4/139; H01M 10/0525; C09J 2203/33

(57) ABSTRACT

Disclosed herein are an electrode assembly for a secondary battery, in which tape is attached to a cut surface to prevent detached debris generated during a cutting process for forming an electrode plate of an electrode assembly from scattering, and a manufacturing method of forming the same. The secondary battery according to the present disclosure includes an electrode plate including a substrate and a coating layer formed on at least one of a front surface and a rear surface of the substrate, and an electrode assembly including a first tape attached to at least one end portion of the electrode plate and extending in an up-down direction on an outer surface of the coating layer. Here, an end-portion surface of the first tape can be aligned to correspond to an end-portion surface of the electrode plate.

### CROSS-REFERENCE TO RELATED APPLICATIONS

This present application claims priority to and the benefit under 35 U.S.C. § 119(a)-(d) of Korean Patent Application No. 10-2025-0045741, filed on Apr. 8, 2025, in the Korean Intellectual Property Office, the entire disclosure of which is incorporated herein by reference.

### FIELD

The present disclosure relates to a secondary battery and a method of forming an electrode assembly used for the same.

### BACKGROUND

Unlike primary batteries that cannot be charged, secondary batteries are batteries that can be charged and discharged. Typically, a secondary battery includes an electrode assembly formed of a positive electrode plate, a negative electrode plate, and a separator interposed therebetween. The positive or negative electrode plates may be manufactured through a coating process of coating one or both surfaces of an electrode substrate with an active material mixture, a roll pressing process of pressing and stretching the electrode plates coated with the mixture through the coating process to form thin, flat electrode plates, a slitting process of cutting the coated electrode plates in multiple rows in a length direction to separate the cut electrode plates into individual electrode plates, and a notching process of cutting the separated individual electrode plate in a transverse direction, removing unnecessary portions, and forming electrode tabs. During the cutting process of forming the electrode plate, some of the mixture may be detached. The generated detached debris may scatter and remain in an unspecified position on the electrode plate. The detached debris may cause electrical short circuits in the electrode assembly or low voltage failures in future process environments including charge/discharge processes and in use environments so that the detached debris may be a factor for degrading product stability and reliability of the secondary battery.

The herein information disclosed in this Background section is for enhancement of understanding of the background of the present disclosure, and therefore, it may contain information that does not constitute the related (or prior) art.

### SUMMARY

The present disclosure is directed to providing a secondary battery with tape attached to a cut surface to prevent detached debris generated during a cutting process for forming an electrode plate from scattering, and a method of manufacturing the same.

According to aspects of the present disclosure, there is provided a secondary battery including an electrode plate including a substrate and a coating layer formed on at least one of a front surface and a rear surface of the substrate, and an electrode assembly including a first tape attached to at least one end portion of the electrode plate and extending in an up-down direction on an outer surface of the coating layer, wherein an end-portion surface of the first tape is aligned to correspond to an end-portion surface of the electrode plate.

According to aspects of the present disclosure, there is provided a method of manufacturing an electrode assembly of a secondary battery, which includes a first operation of providing a coating substrate, on at least one of one surface and the other surface of which a coating layer is formed, in one direction, a second operation of attaching a first base material tape on the coating substrate to correspond to a defined first cutting line, and a third operation of cutting the coating substrate to which the first base material tape is attached along the first cutting line and forming a first divided electrode plate and a second divided electrode plate, to one end portions of which first tapes formed by cutting the first base material tape are attached, wherein the cut first tapes include a 1-1 tape attached to the first divided electrode plate and a 1-2 tape attached to the second divided electrode plate, and an end-portion surface of the 1-1 tape and an end-portion surface of the 1-2 tape may be aligned to correspond to an end-portion surface of the first divided electrode plate and an end-portion surface of the second divided electrode plate, respectively.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The herein and other objects, features and advantages of the present disclosure will become more apparent to those of ordinary skill in the art by describing exemplary embodiments thereof in detail with reference to the accompanying drawings, in which:

FIG. 1 is a structural schematic diagram illustrating a cylindrical secondary battery;

FIG. 2 is a structural schematic diagram illustrating a cylindrical tabless secondary battery;

FIG. 3 is an exemplary diagram illustrating a configuration of an electrode plate that is applied to the electrode assembly of a cylindrical battery;

FIG. 4 is a schematic perspective view illustrating a configuration of the electrode assembly according to embodiments of the present disclosure;

FIGS. 5 and 6 are diagrams for describing a method of manufacturing an electrode assembly according to embodiments of the present disclosure;

FIG. 7 is a schematic perspective view illustrating an electrode assembly according to embodiments of the present disclosure;

FIGS. 8 to 10 are diagrams for describing a method of manufacturing an electrode assembly according to embodiments of the present disclosure;

FIG. 11 is a diagram for describing examples of a method of attaching a second tape; and

FIG. 12 is a schematic diagram illustrating an electrode assembly in which a coating layer is formed on only one side of a substrate.

### DETAILED DESCRIPTION

Hereinafter exemplary embodiments of the present disclosure will be described in detail with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way. Therefore, the embodiments described herein and the configurations shown in the drawings are merely the most exemplary some embodiments of the present disclosure and do not represent all the technical spirit of the present disclosure such that it should be understood that there may be various equivalents and modifications capable of substituting the embodiments and the configurations at the time of filing the present application. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. In addition, the same reference numerals may be assigned to the same components in different embodiments.

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are only used for distinguishing one component from another component, and unless otherwise stated, it is of course that a first component may also be a second component.

Throughout the specification, unless otherwise stated, each element may be singular or plural. Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to one another, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

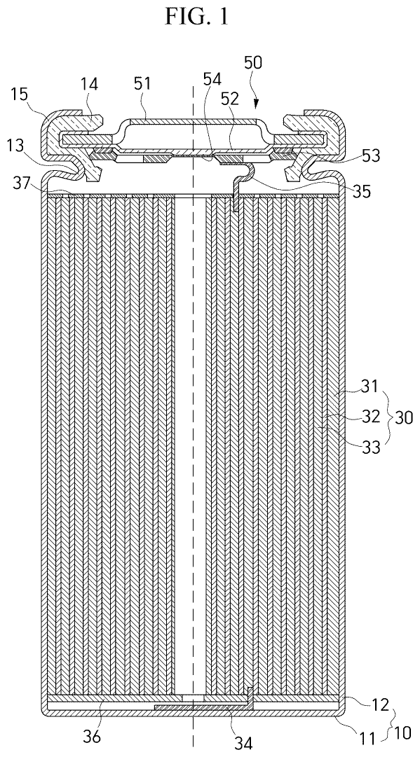

FIG. 1 is a cross-sectional view illustrating an example of a cylindrical secondary battery to which an electrode assembly according to some embodiments of the present disclosure can be applied.

The secondary battery includes an electrode assembly 30, a case 10 accommodating the electrode assembly 30 and an electrolyte therein, a cap assembly 50 coupled to an opening of the case 10 to seal the case 10, and an insulating plate 37 positioned between the electrode assembly 30 and the cap assembly 50 inside the case.

The electrode assembly 30 may include a first electrode plate 33, a separator 32, and a second electrode plate 31. Since the electrode assembly 30 is configured by winding the first electrode plate 33, the separator 32, and the second electrode plate 31 in a roll form, it is referred to as a winding-type electrode assembly or a jelly roll. The first electrode plate 33 of the electrode assembly 30 may serve as a negative electrode, and the second electrode plate 31 may serve as a positive electrode, although the opposite arrangement is also possible.

The first electrode plate 33, when it is a negative electrode, may be formed by applying (e.g., coating or depositing) active material, such as graphite or carbon, onto an electrode substrate formed of a metal foil, such as copper, a copper alloy, nickel, or a nickel alloy. The first electrode plate 33 may include a first electrode tab 35 (e.g., a first uncoated portion), which is a region to which the first electrode active material is not applied. The first electrode tab 35 may be electrically connected to the cap assembly 50.

The second electrode plate 31, when it is a positive electrode, may be formed by applying (e.g., coating or depositing) active material, such as a transition metal oxide, onto an electrode substrate formed of a metal foil, such as aluminum or an aluminum alloy. The second electrode plate 31 may include a second electrode tab 34 (e.g., a second uncoated portion), which is a region to which the second electrode active material is not applied. The second electrode tab 34 may be electrically connected to the case. The first electrode tab 35 and the second electrode tab 34 may extend in opposite directions.

The separator 32 prevents a short-circuit between the first electrode plate 33 and the second electrode plate 31 while allowing movement of lithium ions therebetween. The separator 32 may be made of, for example, a polyethylene film, a polypropylene film, a polyethylene-polypropylene film, or the like.

The case 10 accommodates the electrode assembly 30, and together with the cap assembly 50 forms the external appearance of the secondary battery. The case 10 may have a substantially cylindrical body portion 12 and a bottom portion 11 connected to one side (e.g., to one end) of the body portion 12. A beading part 13 deformed inwardly may be formed in the body portion 12, and a crimping part 15 bent inwardly may be formed at an open end of the body portion 12. The beading part 13 can reduce or prevent movement of the electrode assembly 30 inside the case 10 and can facilitate seating of the gasket 14 and the cap assembly 50.

The crimping part 15 may firmly fix the cap assembly 50 by pressing the edge of the case 10 against the gasket 14. The case 10 may be formed of steel plated with nickel or composite material, for example.

The cap assembly 50 may be fixed to the inside of the crimping part 15 by a gasket 14 to seal the case 10. The cap assembly 50 may include a cap up 51, a safety vent 52, a cap down 53, an insulating member, and a sub plate 54 but is not limited thereto and may be modified in various ways.

The cap up 51 may be positioned at the uppermost part of the cap assembly 50. The cap up 51 may include a terminal part that protrudes upwardly and is connected to an external circuit, and an outlet for discharging gas may be arranged around the terminal part.

The safety vent 52 may be located under the cap up 51. The safety vent 52 may include a protrusion part that protrudes convexly downwardly and is connected to the sub plate 54, and at least one notch may be formed in the safety vent around the protrusion part.

If gas is generated due to overcharging or abnormal operation of the secondary battery, the protrusion part is deformed upwardly by the pressure and separates from the sub plate 54 while the safety vent 52 is cut (e.g., bursts or tears) along the notch. The cut safety vent 52 may prevent the secondary battery from exploding by allowing for the gas to be discharged to the outside.

The cap down 53 may be below the safety vent 52. The cap down 53 may have a first opening for exposing the protrusion part of the safety vent 52 and a second opening for gas discharge. The insulating member may be positioned between the safety vent 52 and the cap down 53 to insulate the safety vent 52 and the cap down 53.

The sub plate 54 may be under the cap down 53. The sub plate 54 may be fixed to a lower surface of the cap down 53 to block the first opening of the cap down 53, and the protrusion part of the safety vent 53 may be fixed to the sub plate 54. The first electrode tab 35, which is drawn out from the electrode assembly 30 may be fixed to the sub plate 54. Accordingly, the cap up 51, the safety vent 52, the cap down 53, and the sub plate 54 may be electrically connected to the first electrode 33 of the electrode assembly 30.

The insulating plate 37 may be positioned to be in contact with the electrode assembly 30 below the beading part 13. The insulating plate 37 may have a tab opening through which the first electrode tab 35 is drawn out. The cap assembly 50, which is electrically connected to the first electrode by the first electrode tab, may face the electrode assembly with an insulating plate 37 interposed therebetween and may maintain a state of being insulated (e.g., electrically insulated) from the electrode assembly 30 by the insulating plate 37. Meanwhile, another insulating plate 36 may be included for insulation between the electrode assembly 30 and the bottom portion 11 of the case 10.

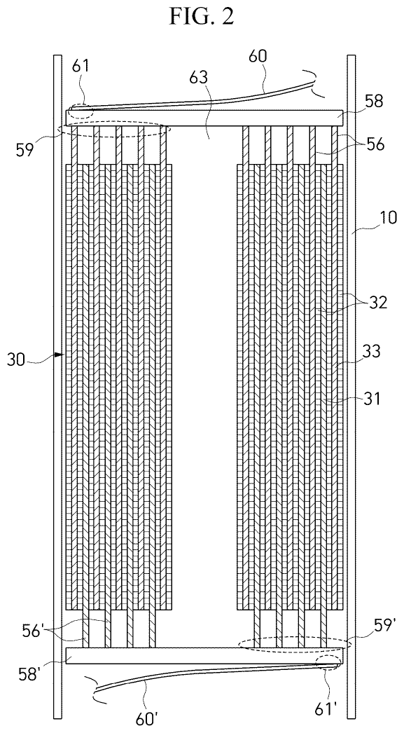

FIG. 2 is a cross-sectional view illustrating another example of a cylindrical secondary battery to which the electrode assembly according to some embodiments of the present disclosure can be applied. The cylindrical secondary battery in the example is referred to as a cylindrical tabless secondary battery.

An electrode assembly 30 is accommodated inside a case 10. Like the cylindrical secondary battery of FIG. 1, the electrode assembly 30 may be a jelly-roll type electrode assembly in which a first electrode plate 33, a separator 32, and a second electrode plate 31 are wound. Here, the first electrode plate 33 may serve as a positive electrode and the second electrode plate 31 may serve as a negative electrode, but the present disclosure is not limited thereto.

In the cylindrical secondary battery type of FIG. 2, the electrode tab 35 of the first electrode plate 33 shown in FIG. 1 may be omitted, and a current collector plate 58 may be directly bonded to an uncoated portion (electrode material uncoated portion) 56. A bonded portion between the uncoated portion 56 and the current collector plate 58 is denoted as a first welded portion 59. A lead tab 60 may be bonded to an upper surface of the current collector plate 58 and connected to a terminal (not shown) exposed to the outside. A bonded portion between the current collector plate 58 and the lead tab 60 is indicated as a first welded portion 61. The bonding may be performed by laser welding. Laser welding can perform welding on the thin and uncoated portions without deformation in a non-contact manner.

Similarly, the electrode tab 34 of FIG. 1 of the second electrode plate 31 may be omitted, and a current collector plate 58′ may be directly bonded to an uncoated portion 56′ (electrode material uncoated portion) of the second electrode plate 31. A lead tab 60′ may be bonded to a lower surface of the current collector plate 58′. A bonded portion between the current collector plate 58′ and the lead tab 60′ is indicated as a first welded portion 61′. The bonding may also be performed by laser welding.

Since the current collector plate 58 is directly connected to the uncoated portion 56 of the electrode plate 33 without the electrode tab 35, this cylindrical battery is also referred to as a tabless cylindrical battery. The cylindrical tabless battery is a battery platform in which passages (e.g., the current collector plates 58 and 58′), through which electrons can move, increase. The cylindrical tabless battery is used in high-power models because it is possible to exhibit low resistance performance (10 mΩ or less) at ultra-high power (65 A or more), and the demand for the cylindrical tabless battery is growing worldwide. In order to remove the electrode tabs used in the conventional cylindrical battery, a current collector plate is used instead of the existing electrode tab, enabling current to be transmitted to the electrode assembly over a wide area.

In addition, in the cylindrical battery according to the embodiments of the present disclosure shown in FIG. 2, the beading portion 13 shown in FIG. 1 is omitted. This cylindrical battery is also referred to as a beading-less cylindrical battery. Recently, as cylindrical cells are increasingly being employed in automobiles, there are increasing instances of increasing the sizes of existing cylindrical cells. For example, large-diameter cells are being manufactured, and cells in the form in which space-consuming structures (e.g., beading sections) are removed to increase capacity are being manufactured. The beading portion 13 of FIG. 1 is omitted so that the usability of an upper space of the cylindrical battery may be increased.

As another method of increasing battery capacity or energy density, in order to minimize a winding core portion 63 of the wound electrode assembly 30, the electrode plate may be located deep within the winding core portion 63.

Materials that may be used in electrode assemblies according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O₂-_{c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O₂-ₐDₐ (0.90≤a≤1.8, 0≤b≤0.5, 0≤c≤0.5, 0<α<2); LiₐNi_{b}CO_{c}L¹_{d}GₑO₂ (0.90≤a≤1.8, 0≤≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99.5 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate. The organic material may include a polyvinylidene fluoride-based polymer or a (meth)acrylic polymer.

The inorganic material may include inorganic particles selected from Al2O3, SiO2, TiO2, SnO2, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on one another.

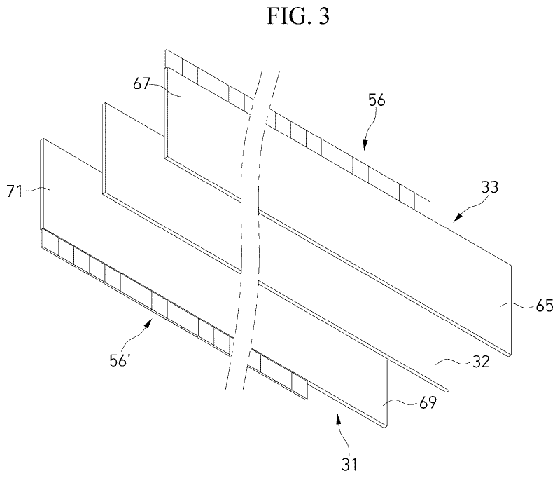

FIG. 3 illustrates configurations of an electrode plate and a separator constituting a winding-type electrode assembly of a secondary battery according to some embodiments of the present disclosure. The electrode assembly configuration of FIG. 3 may be applied to the cylindrical battery of FIG. 2 described herein, but the present disclosure is not limited thereto.

Referring to FIG. 3, the electrode assembly of the secondary battery according to some embodiments of the present disclosure may include a first electrode plate 33, a second electrode plate 31, and a separator 32 interposed between the first electrode plate 33 and the second electrode plate 31. The electrode assembly may be wound in the form of a roll.

The first electrode plate 33 may include a first uncoated portion 56 provided on one side in a longitudinal direction. The first uncoated portion 56 may have a plurality of cut pieces that are cut by a plurality of transverse cut lines. A portion of each cut piece may be connected to a substrate of the first electrode plate 33. Each cut piece may be an extended portion of the substrate of the first electrode plate 33.

One end 65 of the first electrode plate 33 may be an end corresponding to or connected to the winding core portion 63 of FIG. 2 that is to be located at a central portion inside a roll after being wound in a roll shape, and the other end 67 may be an end that is to be located at an outer side of the roll of the electrode assembly 30 after winding.

Similar to the first electrode plate 33, the second electrode plate 31 may include a second uncoated portion 56′ provided on one side in the longitudinal direction. The second uncoated portion 56′ may be located on an opposite side in the longitudinal direction of the first uncoated portion 56. The second uncoated portion 56′ may have a plurality of cut pieces that are cut by a plurality of transverse cut lines. A portion of each cut piece may be connected to a substrate of the second electrode plate 31. Each cut piece may be an extended portion of the substrate of the second electrode plate 31.

One end 69 of the second electrode plate 31 may be an end corresponding to or connected to the winding core portion 63 of FIG. 2 that is to be located at an inner core after winding, and the other end 71 may be an end that is to be located at an outer side of the electrode assembly 30 after winding.

Prior to describing exemplary embodiments of the present disclosure, it is obvious that axes shown in the drawings, terms indicating the axes, and terms indicating directions such as an up-down direction (or a Z-axis direction), a front-rear direction (or a Y-axis direction), a left-right direction (or an X-axis direction) and the like described based on corresponding axes are only intended to present relative references for describing embodiments of the present disclosure and are not intended to specify any direction or position in absolute terms and may vary relatively according to a position of the target object, a position of the observer, a viewing direction, etc.

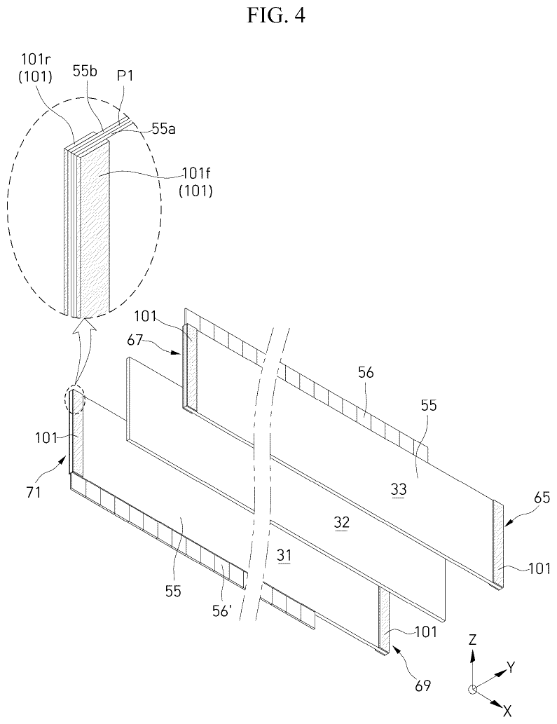

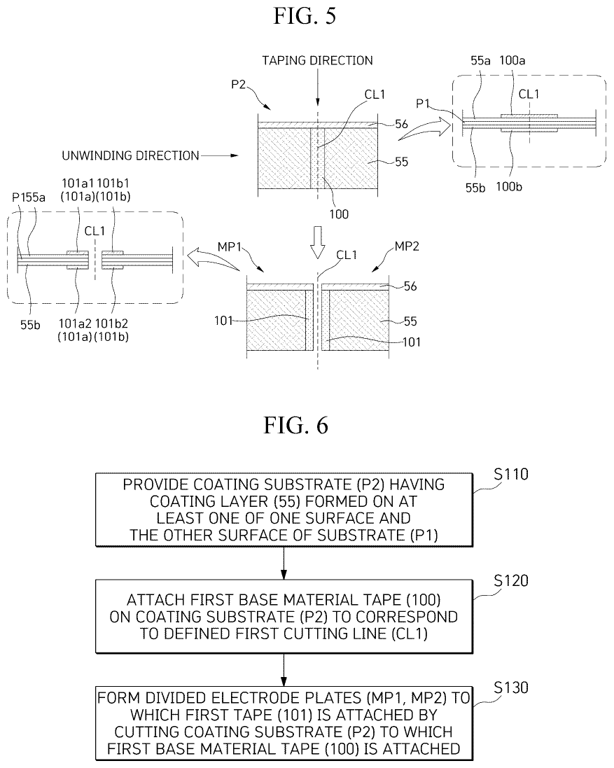

In addition, hereinafter, an example of the winding-type electrode assembly with the configuration exemplified in FIG. 3 will be described as a representative example, but the present disclosure is not limited thereto and may be applied to other types of electrode assemblies such as a stacking-type electrode assembly and a Z-stack type electrode assembly. FIG. 4 is a schematic perspective view illustrating the electrode assembly of the secondary battery according to embodiments of the present disclosure. FIGS. 5 and 6 are diagrams for describing a method of manufacturing an electrode assembly according to embodiments of the present disclosure.

Referring to FIG. 4, the electrode assembly 30 may include a first electrode plate 33, a second electrode plate 31, and a separator 32 interposed between the first electrode plate 33 and the second electrode plate 31.

The first electrode plate 33 and the second electrode plate 31 may include a substrate P1 and a coating layer 55 formed on at least one of one surface and the other surface of the substrate P1.

The coating layer 55 may be a layer formed by coating the substrate P1 with a mixture. The mixture contains an active material and may further contain a binder and a solvent. As described herein, the first electrode plate 33 may serve as a positive electrode. In this case, the substrate P1 of the first electrode plate 33 may be made of, for example, aluminum foil, and the active material may contain, for example, a transition metal oxide. The second electrode plate 31 may serve as a negative electrode. In this case, the substrate P1 of the second electrode plate 31 may be made of, for example, copper foil or nickel foil, and the active material may contain, for example, graphite. However, the present disclosure is not limited thereto. Hereinafter, an example in which the electrode plates 31 and 33 include a first coating layer 55a formed on a front surface of the substrate P1 and a second coating layer 55b formed on a back surface of the substrate P1 will be described.

The first electrode plate 33 and the second electrode plate 31 are provided to correspond to an upper or lower end portion and may include uncoated portions 56 and 56′ defined as areas not formed in the coating layer 55 on the substrate P1. For example, the uncoated portion 56 of the first electrode plate 33 may be formed to correspond to the upper end portion of the electrode assembly 30, and the uncoated portion 56′ of the second electrode plate 31 may be formed to correspond to the lower end portion of the electrode assembly 30.

The electrode assembly 30 may include a tape 101 attached to at least one of the first electrode plate 33 and the second electrode plate 31. The tape 101 may be attached to one end of each of the electrode plates 31 and 33. Preferably, the tape 101 may be attached to both the first electrode plate 33 and the second electrode plate 31.

The tape may include a first tape 101. The first tape 101 may be made of a material selected from polycarbonate (PC), polyethylene terephthalate (PET), polypropylene (PP), and polyethylene (PE), but the present disclosure not limited thereto.

The first tape 101 may be attached to at least one end of the electrode plates 31 and 33. Preferably, the first tape 101 may be attached to all of one ends 65 and 69 and the other ends 67 and 71 of the electrode plates 31 and 33. The first tape 101 may be attached on the coating layers 55 of the electrode plates 31 and 33. An end-portion surface of the first tape 101 may be aligned with end-portion surfaces of the electrode plates 31 and 33. This may mean that the end-portion surface of the first tape 101 does not protrude from the end portions 65, 67, 69, and 71 of the electrode plates 31 and 33 and that the end-portion surface of the first tape 101 and the end-portion surfaces of the electrode plates 31 and 33 may form a substantially single flat surface. Here, the end-portion surface may refer to a cut surface.

The first tape 101 may cover the entire surface of the coating layer 55 at the end portions 65, 67, 69, and 71 of the electrode plates 31 and 33. The first tape 101 may not cover side surfaces of the coating layer 55 at the end portions 65, 67, 69, and 71 of the electrode plates 31 and 33. Preferably, the first tape 101 may not cover upper and lower surfaces of the coating layer 55 at the end portions 65, 67, 69, and 71 of the electrode plates 31 and 33. Preferably, the first tape 101 may not be located in the uncoated portions 56 and 56′.

The first tape 101 may include a front surface tape 101f attached to the first coating layer 55a and a rear surface tape 101r attached to the second coating layer 55b. The front surface tape 101f and the rear surface tape 101r overlap one another with the substrate P1, the first coating layer 55a, and the second coating layer 55b interposed therebetween and may not be in contact with one another.

Referring further to FIGS. 5 and 6, a method of manufacturing the electrode assembly 30 of a secondary battery according to embodiments of the present disclosure may include first to third operations S110, S120, and S130.

In the first operation S110, a coating substrate P2 having a coating layer 55 formed on at least one of one surface and the other surface of the substrate P1 may be provided in one direction. Preferably, the coating layer 55 may be formed on both one surface and the other surface of the substrate P1. That is, the coating layer 55 may include a first coating layer 55a formed on the front surface of the substrate P1 and a second coating layer 55b formed on the rear surface thereof. In the first operation S110, a coating substrate supply roller (not shown) on which the coating substrate P2 is wound may be provided. The coating substrate P2 may be unwound from the coating substrate supply roller in one direction.

The second operation S120 may include an operation of attaching a first base material tape 100 on the provided coating substrate P2. The second step S120 may include an operation of defining a first cutting line CL1 on the coating substrate P2. The first cutting line CL1 may be a cutting position of the coating substrate P2 that is preset in accordance with a size of the electrode plate. The first cutting line CL1 may be set in consideration of specifications and a tolerance range of a cutting device. The first cutting line CL1 may be set in a direction intersecting the direction in which the coating substrate P2 is provided.

The second operation S120 may be an operation of attaching the first base material tape 100 on the coating substrate P2 to correspond to the defined first cutting line CL1. For example, in the second operation S120, a tape supply roller (not shown) on which the first base material tape 100 is wound may be provided. The first base material tape 100 may be unwound in one direction from the tape supply roller and attached onto the coating substrate P2. The attachment direction of the first base material tape 100 may be a direction intersecting the direction in which the coating substrate P2 is provided.

The first base material tape 100 may be attached onto the coating layer 55. One end of the first base material tape 100 may extend toward one side based on the first cutting line CL1, and the other end thereof may extend toward the other side based on the first cutting line CL1. The first base material tape 100 may include a 1-1 base material tape 100a attached to the first coating layer 55a, and a 1-2 base material tape 100b attached to the second coating layer 55b.

The third operation S130 may be an operation of forming individual electrode plates by cutting the coating substrate P2 to which the first base material tape 100 is attached. In the third operation S130, the coating substrate P2 to which the first base material tape 100 is attached may be cut along the first cutting line CL1. In the third operation S130, a first divided electrode plate MP1 and a second divided electrode plate MP2 in which the first tape 101 is attached to ends may be formed. The first tape 101 may be a tape formed by cutting the first base material tape 100.

The cut first tape 101 may include a 1-1 tape 101a attached to the first divided electrode plate MP1 and a 1-2 tape 101b attached to the second divided electrode plate MP2. An end-portion surface of the 1-1 tape 101a may be aligned with an end-portion surface of the first divided electrode plate MP1. An end-portion surface of the 1-2 tape 101b may be aligned with an end-portion surface of the second divided electrode plate MP2. Since the first base material tape 100 and the coating substrate P2 are cut simultaneously, the end-portion surface of the 1-1 tape 101a, the end-portion surface of the first divided electrode plate MP1, the end-portion surface of the 1-2 tape 101b, and the end-portion surface of the second divided electrode plate MP2 may be aligned to form a substantially single flat surface. The end-portion surface may refer to a cut surface.

The 1-1 tape 101a may include at least one of a 1-1 front surface tape 101a1 attached to the first coating layer 55a and a 1-1 rear surface tape 101a2 attached to the second coating layer 55b. The 1-2 tape 101b may include at least one of a 1-2 front surface tape 101b1 formed on the first coating layer 55a and a 1-2 rear surface tape 101b2 formed on the second coating layer 55b. The 1-1 front surface tape 101a1 and the 1-2 front surface tape 101b1 may be tape prepared by cutting the 1-1 base material tape 100a, and the 1-1 rear surface tape 101a2 and the 1-2 rear surface tape 101b2 may be tape prepared by cutting the 1-2 base material tape 100b.

The 1-1 front surface tape 101a1 may cover the first coating layer 55a at an end portion of the first divided electrode plate MP1. The 1-1 front surface tape 101a1 may not cover a side surface of the first coating layer 55a at the end portion of the first divided electrode plate MP1. Preferably, the 1-1 front surface tape 101a1 may not cover a lower surface of the first coating layer 55a at the end portion of the first divided electrode plate MP1. Preferably, the 1-1 front surface tape 101a1 may not be located in the uncoated portions 56 and 56′. The 1-1 rear surface tape 101a2 may cover the second coating layer 55b at the end portion of the first divided electrode plate MP1. The 1-1 rear surface tape 101a2 may not cover a side surface of the second coating layer 55b at the end portion of the first divided electrode plate MP1. Preferably, the 1-1 rear surface tape 101a2 may not cover a lower surface of the second coating layer 55b at the end portion of the first divided electrode plate MP1. Preferably, the 1-1 rear surface tape 101a2 may not be located in the uncoated portions 56 and 56′.

The 1-2 front surface tape 101b1 may cover the first coating layer 55a at an end portion of the second divided electrode plate MP2. The 1-2 front surface tape 101b1 may not cover the side surface of the first coating layer 55a at the end portion of the second divided electrode plate MP2. Preferably, the 1-2 front surface tape 101b1 may not cover a lower surface of the first coating layer 55a at the end portion of the first divided electrode plate MP1. Preferably, the 1-2 front surface tape 101b1 may not be located in the uncoated portions 56 and 56′. The 1-2 rear surface tape 101b2 may cover the second coating layer 55b at the end portion of the second divided electrode plate MP2. The 1-2 rear surface tape 101b2 may not cover the side surface of the second coating layer 55b at the end portion of the second divided electrode plate MP2. Preferably, the 1-2 rear surface tape 101b2 may not cover the lower surface of the second coating layer 55b at the end portion of the second divided electrode plate MP2. Preferably, the 1-2 rear surface tape 101b2 may not be located in the uncoated portions 56 and 56′.

Each of the first divided electrode plate MP1 and the second divided electrode plate MP2 formed by the method of manufacturing the electrode assembly 30 according to embodiments of the present disclosure may serve as a negative electrode plate or a positive electrode plate. During the cutting process of the coating substrate, some of the mixture may be detached. The generated detached debris may scatter and remain in an unspecified position on the electrode plate. The detached debris may cause electrical short circuits in the electrode assembly or low voltage failures in future process environments including charge/discharge processes and in use environments so that the detached debris may be a factor for degrading product stability and reliability of the secondary battery. To prevent defects due to detached debris, a method of attaching tape to the cut surface after the cutting process is performed may be considered. In this case, since the tape is attached in a state in which the detached debris has already scattered, the detached debris may remain in an unspecified position on the electrode plate in subsequent process and/or use environments. This may mean that the herein-described defects may still occur.

According to embodiments of the present disclosure, since a first tape is attached in advance to correspond to the cutting surface, i.e., the cutting line, before the cutting process, a problem in which detached debris is scattered during the cutting process can be prevented. Therefore, embodiments of the present disclosure has the advantage of being able to provide an electrode assembly in which product stability and reliability are secured.

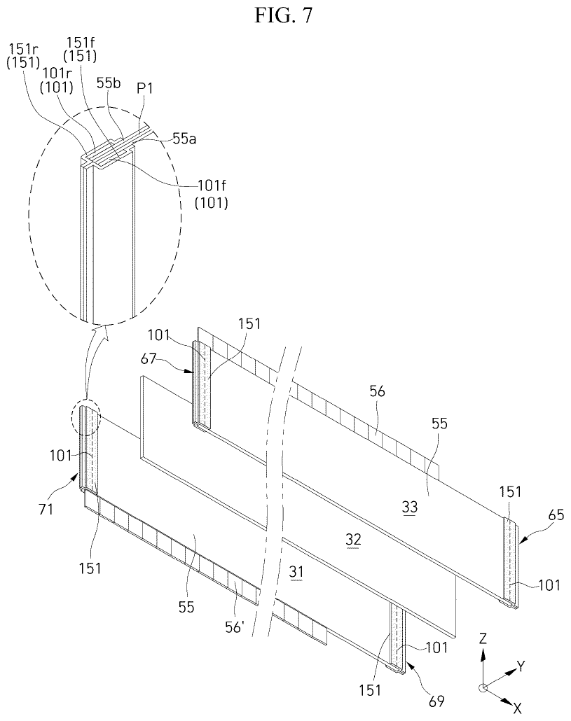

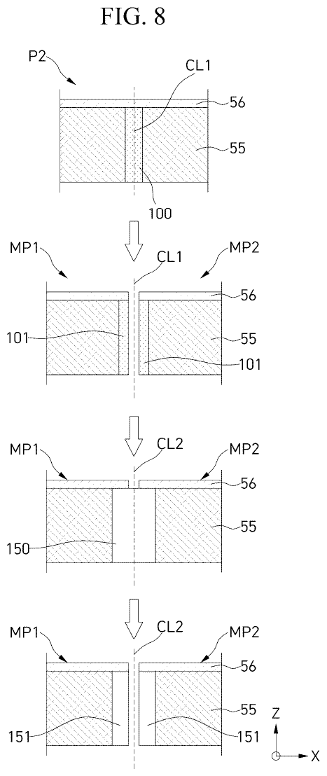

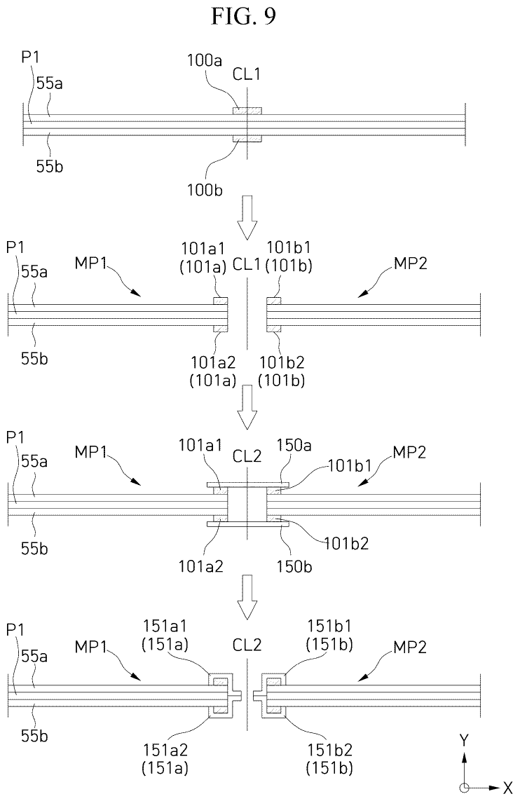

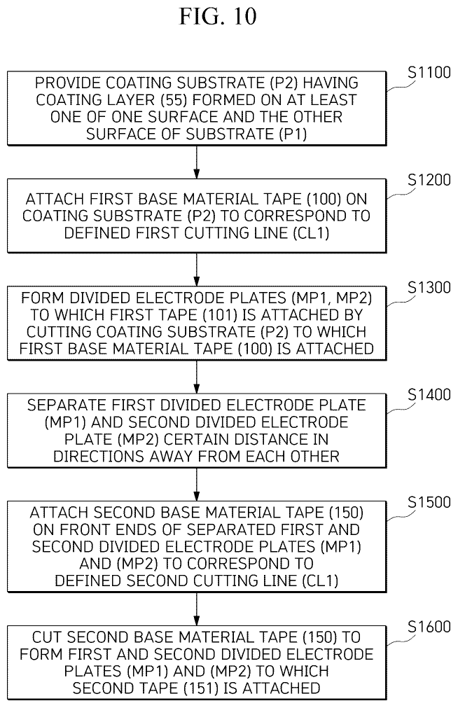

FIG. 7 is a schematic perspective view illustrating an electrode assembly according to embodiments of the present disclosure. FIGS. 8 to 10 are diagrams for describing a method of manufacturing an electrode assembly according to embodiments of the present disclosure. FIG. 11 is a diagram for describing another example of a method of attaching a second tape. In describing embodiments of the present disclosure, a description of a configuration substantially the same as a configuration of embodiments of the present disclosure described herein may be omitted.

Referring to FIG. 7, an electrode assembly 30 according to embodiments of the present disclosure may include tapes 101 and 151 attached to electrode plates 31 and 33. The electrode assembly 30 may include tapes 101 and 151 attached to at least one of the first electrode plate 33 and the second electrode plate 31. The tapes 101 and 151 may be attached to one ends of the electrode plates 31 and 33. Preferably, the tapes 101 and 151 may be attached to both the first electrode plate 33 and the second electrode plate 31.

The tapes 101 and 151 may include a first tape 101 and a second tape 151. Each of the first tape 101 and the second tape 151 may be made of a PC, PET, PP, and PE, but the present disclosure is not limited thereto. For example, the second tape 151 may be formed of a material different from that of the first tape 101 and formed of a material having relatively high rigidity and/or heat resistance. For example, the material of the second tape 151 may be PC having relatively high rigidity, and the material of the first tape 101 may be any one of PET, PP, and PE.

The first tape 101 may be attached to at least one end of the electrode plates 31 and 33. Preferably, the first tape 101 may be attached to all of one ends 65 and 69 and the other ends 67 and 71 of the electrode plates 31 and 33. The first tape 101 may be attached on the coating layers 55 of the electrode plates 31 and 33. An end-portion surface of the first tape 101 may be aligned with end-portion surfaces of the electrode plates 31 and 33. This may mean that the end portion of the first tape 101 does not protrude from the end portions 65, 67, 69, and 71 of the electrode plates 31 and 33 and that the end-portion surface of the first tape 101 and end-portion surfaces of the electrode plates 31 and 33 may form a substantially single flat surface. The end-portion surface may refer to a cut surface.

The first tape 101 may cover the entire surface of the coating layer 55 at the end portions 65, 67, 69, and 71 of the electrode plates 31 and 33. The first tape 101 may not cover side surfaces of the coating layer 55 at the end portions 65, 67, 69, and 71 of the electrode plates 31 and 33. Preferably, the first tape 101 may not cover upper and lower surfaces of the coating layer 55 at the end portions 65, 67, 69, and 71 of the electrode plates 31 and 33. Preferably, the first tape 101 may not be located in the uncoated portions 56 and 56′.

The first tape 101 may include a front surface tape 101f attached to the first coating layer 55a and a rear surface tape 101r attached to the second coating layer 55b. The front surface tape 101f and the rear surface tape 101r overlap one another with the substrate P1, the first coating layer 55a, and the second coating layer 55b interposed therebetween and may not be in contact with one another.

The second tape 151 may be attached to at least one end of the electrode plates 31 and 33. Preferably, the second tape 151 may be attached to all of one ends 65 and 69 and the other ends 67 and 71 of the electrode plates 31 and 33. The second tape 151 may be attached on the first tape 101 of electrode plates 31 and 33. The second tape 151 may extend while covering an outer surface of the first tape 101. An end portion of the second tape 151 may extend longer than an end portion of the first tape 101. The end portion of the second tape 151 may extend longer than the end portion of the first electrode plate 33 and may protrude outside the electrode plates 31 and 33.

More specifically, the second tape 151 may cover the entire surface of the first tape 101 at the end portions 65, 67, 69, and 71 of the electrode plates 31 and 33. One end of the second tape 151 may extend longer than one end of the first tape 101 to cover at least a portion of the side surface of the coating layer 55. The other end of the second tape 151 may extend longer than the other end of the first tape 101 to cover at least a portion of the front surface of the coating layer 55. Preferably, a lower end portion of the second tape 151 may extend longer than a lower end portion of the first tape 101 to cover at least a portion of a lower surface of the coating layer 55. Preferably, the second tape 151 may not be located in the uncoated portions 56 and 56′.

The second tape 151 may include a second front surface tape 151f extending to cover the first front surface tape 101f and a second rear surface tape 151r extending to cover the first rear surface tape 101r. For example, an end portion of the second front surface tape 151f and an end portion of the second rear surface tape 151r may extend laterally and come into contact. An adhesive surface of the second front surface tape 151f and an adhesive surface of the second rear surface tape 151r may be bonded and fixed by coming into contact with one another. As another example, the adhesive surface of the second front surface tape 151f may be attached to the side surface of the first coating layer 55a, and the adhesive surface of the second rear surface tape 151r may be attached to the side surface of the second coating layer 55b. When necessary, any one of the second front surface tape 151f and the second rear surface tape 151r may extend to cover at least a portion of an outer surface of the other one and the adhesive surface may come into contact with the outer surface of the other one to maintain a fixed state.

Referring further to FIGS. 8 to 10, a method of manufacturing an electrode assembly according to embodiments of the present disclosure may include first to sixth operations S1100, S1200, S1300, S1400, S1500, and S1600. The first to third operations S1100, S1200, and S1300 according to embodiments of the present disclosure may be substantially the same as the first to third operations S110, S120, and S130 according to embodiments of the present disclosure. The fourth operation S1400 may be an operation of separating the first divided electrode plate MP1 to which the 1-1 tape 101a is attached and the second divided electrode plate MP2 to which the 1-2 tape 101b is attached a certain distance in directions away from one another. The first divided electrode plate MP1 may be separated a preset distance toward one side based on the first cutting line CL1, and the second divided electrode plate MP2 may be separated a preset distance toward the other side based on the first cutting line CL1.

The fifth operation S1500 may be an operation of attaching the second base material tape 150 on the separated first and second divided electrode plates MP1 and MP2. The fifth operation S1500 may include an operation of defining a second cutting line CL2 between the separated first and second divided electrode plates MP1 and MP2. The second cutting line CL2 may be set in a direction intersecting the direction in which the coating substrate P2 is provided. The second cutting line CL2 may be substantially the same as the first cutting line CL1. The fifth operation S1500 may include an operation of attaching the second base material tape 150 to one end portions of the first and second divided electrode plates MP1 and MP2 to correspond to the defined second cutting line CL2. For example, in the fifth operation S1500, a tape supply roller (not shown) on which the second base material tape 150 is wound may be provided. The second base material tape 150 may be unwound in one direction from the tape supply roller and attached to correspond to the one end portions of the separated first and second divided electrode plates MP1 and MP2. The attachment direction of the second base material tape 150 may be a direction intersecting the direction in which the coating substrate P2 is provided. The attachment direction of the second base material tape 150 may be substantially the same as the attachment direction of the first base material tape 100.

One end and the other end of the second base material tape 150 may be attached on the first and second divided electrode plates MP1 and MP2 to cover the 1-1 tape 101a and the 1-2 tape 101b. One end of the second base material tape 150 may extend toward one side based on the second cutting line CL2, and the other end thereof may extend toward the other side based on the second cutting line CL2. The second base material tape 150 may include a 2-1 base material tape 150a attached on the 1-1 front surface tape 101a1 and the 1-2 front surface tape 101b1 and a 2-2 base material tape 150b attached on the 1-1 rear surface tape 101a2 and the 1-2 rear surface tape 101b2. Preferably, the second base material tape 150 may be attached to protrude from a lower end portion of each of the first and second divided electrode plates MP1 and MP2. The sixth operation S1600 may be an operation of cutting the second base material tape 150 along the second cutting line CL2. In the sixth operation S1600, the second base material tape 150 may be cut along the second cutting line CL2. In the sixth operation S1600, the first and second divided electrode plates MP1 and MP2 with the second tape 151 attached to end portions may be formed. The second tape 151 may be tape formed by cutting the second base material tape 150.

The second tape 151 may be attached to the end portions of the first and second divided electrode plates MP1 and MP2. The second tape 151 may be attached to the first tape 101 of the first and second divided electrode plate MP1 and MP2. The second tape 151 may extend while covering an outer surface of the first tape 101. An end portion of the second tape 151 may extend longer than an end portion of the first tape 101. The end portion of the second tape 151 may extend further than the end portions of the first and second divided electrode plate MP1 and MP2 to protrude outward from the first and second divided electrode plate MP1 and MP2.

The cut second tape 151 may include a 2-1 tape 151a attached to the first divided electrode plate MP1 and a 2-2 tape 151b attached to the second divided electrode plate MP2. The 2-1 tape 151a may include at least one of a 2-1 front surface tape 151a1 covering the 1-1 front surface tape 101a1 and a 2-1 rear surface tape 151a2 covering the 1-1 rear surface tape 101a2. The 2-2 tape 151b may include at least one of a 2-2 front surface tape 151b1 covering the 1-2 front surface tape 101b1 and a 2-2 rear surface tape 151b2 covering the 1-2 rear surface tape 101b2. The 2-1 front surface tape 151a1 and the 2-2 front surface tape 151b1 may be prepared by cutting the 2-1 base material tape 150a, and the 2-1 rear surface tape 151a2 and the 2-2 rear surface tape 151b2 may be prepared by cutting the 2-2 base material tape 150b. Preferably, the 2-1 tape 151a and the 2-2 tape 151b may extend longer than the 1-1 tape 101a and the 1-2 tape 101b, respectively, to cover at least a portion of the lower surface of the coating layer 55. As an example, an end portion of the 2-1 surface tape 151a1 and an end portion of the 2-1 rear surface tape 151a2 may extend laterally and come into contact with one another. An adhesive surface of the 2-1 front surface tape 151a1 and an adhesive surface of the 2-1 rear surface tape 151a2 may be bonded and fixed by coming into contact with one another. An end portion of the 2-2 front surface tape 151b1 and an end portion of the 2-2 rear surface tape 151b2 may extend laterally and come into contact with one another. An adhesive surface of the 2-2 front surface tape 151b1 and an adhesive surface of the 2-2 rear surface tape 151b2 may be bonded and fixed by coming into contact with one another.

As another example, as shown in FIG. 11, the adhesive surface of the 2-1 front surface tape 151a1 may be attached to the side surface of the first coating layer 55a, and the adhesive surface of the 2-1 rear surface tape 151a2 may be attached to the side surface of the second coating layer 55b. When necessary, any one of the 2-1 front surface tape 151a1 and the 2-1 rear surface tape 151a2 may extend to cover at least a portion of an outer surface of the other one and the adhesive surface may come into contact with the outer surface of the other one to maintain a fixed state. The adhesive surface of the 2-2 front surface tape 151b1 may be attached to the side surface of the first coating layer 55a, and the adhesive surface of the 2-2 rear surface tape 151b2 may be attached to the side surface of the second coating layer 55b. When necessary, any one of the 2-2 front surface tape 151b1 and the 2-2 rear surface tape 151b2 may extend to cover at least a portion of an outer surface of the other one and the adhesive surface may come into contact with the outer surface of the other one to maintain a fixed state.

During subsequent processes including an HPC process, expansion and contraction of the electrode plates 31 and 33 may occur due to heat provided to the electrode assembly. For example, due to the material properties of the negative electrode plates 31 and 33, deformation such as expansion and contraction can occur due to heat, and during the deformation process, the separator 32 may be damaged, which may cause defects such as an electrical short circuit with the positive electrode plates 31 and 33.

In embodiments of the present disclosure, the end-portion surfaces of the electrode plates 31 and 33, preferably the cut surfaces of the electrode plates 31 and 33, may be covered using the second tape 151. Accordingly, in embodiments of the present disclosure, the second tape 151 is provided on at least one end of the electrode plates 31 and 33 so that deformation of the electrode plates 31 and 33 can be prevented in a given process environment and/or electrical failures that may occur due to contact with the separator 32 in response to deformation of the electrode plates 31 and 33 can be reduced. In addition, as described herein, the second tape 151 may be formed of a material having a predetermined rigidity and/or heat resistance compared to the first tape 101. Accordingly, the second tape 151 has the advantage of effectively preventing thermal deformation of the electrode plates 31 and 33 and damage to the separator 32.

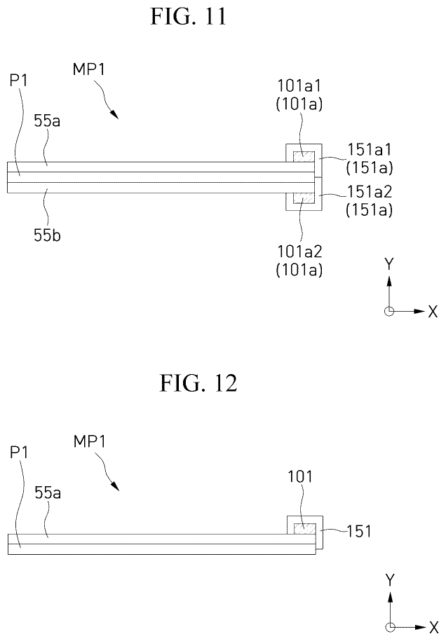

FIG. 12 is a schematic diagram illustrating an electrode assembly in which a coating layer is formed on only one side of a substrate. As shown in FIG. 12, the electrode plates 31 and 33 may include a substrate and a coating layer formed only on one surface of the substrate. The first tape 101 and the second tape 151 may be attached to end portions of the electrode plates 31 and 33. Descriptions for the first tape 101 and the second tape 151 may be substantially the same as those described herein.

According to embodiments of the present disclosure, since tape is attached to correspond to a cut surface in advance prior to a process of cutting an electrode plate constituting an electrode assembly, a problem in which flying debris is scattered during the cutting process can be prevented. Therefore, the present disclosure has the advantage of being able to provide an electrode assembly in which product stability and reliability are secured.

According to embodiments of the present disclosure, a cut surface of the electrode plate can be covered with tape. Therefore, deformation of the electrode plate in a given process environment can be prevented and/or electrical failures (short circuit, etc.) that can occur due to contact with the separator in response to deformation of the electrode plate can be reduced.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery comprising:
an electrode plate comprising a substrate and a coating layer formed on at least one of a front surface and a rear surface of the substrate; and
an electrode assembly comprising a first tape attached to at least one end portion of the electrode plate and extending in an up-down direction on an outer surface of the coating layer,
wherein an end-portion surface of the first tape is aligned to correspond to an end-portion surface of the electrode plate.

2. The secondary battery as claimed in claim 1, wherein the electrode assembly further comprises a second tape attached to one end of the electrode plate and extending to cover at least a portion of a side surface of the coating layer while covering an outer surface of the first tape.

3. The secondary battery as claimed in claim 2, wherein the second tape extends longer than the first tape and covers at least a portion of a lower surface of the coating layer.

4. The secondary battery as claimed in claim 2, wherein:
the coating layer comprises a first coating layer formed on the front surface of the substrate and a second coating layer formed on the rear surface of the substrate; and
the first tape comprises a first front surface tape attached to the first coating layer and a first rear surface tape attached to the second coating layer.

5. The secondary battery as claimed in claim 4, wherein the second tape comprises a second front surface tape extending to cover the first front surface tape and a second rear surface tape extending to cover the first rear surface tape.

6. The secondary battery as claimed in claim 5, wherein an adhesive surface of the second front surface tape and an adhesive surface of the second rear surface tape are attached by coming into contact with one another.

7. The secondary battery as claimed in claim 5, wherein:
an adhesive surface of the second front surface tape is attached to a side surface of the first coating layer; and
an adhesive surface of the second rear surface tape is attached to a side surface of the second coating layer.

8. The secondary battery as claimed in claim 7, wherein any one of the second front surface tape and the second rear surface tape extends to cover at least a portion of an outer surface of the other surface tape to overlap another.

9. The secondary battery as claimed in claim 2, wherein:
the electrode plate is provided to correspond to an upper end portion and comprises an uncoated portion, which is an area in which the coating layer is not formed; and
the first tape and the second tape are not located in the uncoated portion.

10. The secondary battery as claimed in claim 2, wherein:
the electrode plate comprises the first electrode plate and the second electrode plate, to at least one end portion of each of which the first tape and the second tape are attached; and
the first electrode plate and the second electrode plate are wound with a separator interposed therebetween.

11. A method of manufacturing an electrode assembly for a secondary battery, comprising:
a first operation of providing a coating substrate, on at least one of one surface and the other surface of which a coating layer is formed, in one direction;
a second operation of attaching a first base material tape on the coating substrate to correspond to a defined first cutting line; and
a third operation of cutting the coating substrate to which the first base material tape is attached along the first cutting line and forming a first divided electrode plate and a second divided electrode plate, to one end portions of which first tapes formed by cutting the first base material tape are attached,
wherein the cut first tapes comprise a 1-1 tape attached to the first divided electrode plate and a 1-2 tape attached to the second divided electrode plate, and
an end-portion surface of the 1-1 tape and an end-portion surface of the 1-2 tape are aligned to correspond to an end-portion surface of the first divided electrode plate and an end-portion surface of the second divided electrode plate, respectively.

12. The method as claimed in claim 11, wherein, in the second operation, a direction in which the first base material tape is attached is a direction intersecting a direction in which the coating substrate is provided in the first operation.

13. The method as claimed in claim 11, further comprising:
a fourth operation of separating the first divided electrode plate to which the 1-1 tape is attached and the second divided electrode plate to which the 1-2 tape is attached a certain distance in directions away from one another;
a fifth operation of attaching a second base material tape on the first divided electrode plate and the second divided electrode plate so that one end and the other end of the second base material tape cover the 1-1 tape and the 1-2 tape to correspond to a second cutting line defined between the separated first and second divided electrode plates; and
a sixth operation of cutting the second base material tape along the second cutting line and forming the first divided electrode plate and the second divided electrode plate, to one end portions of which second tapes formed by cutting the second base material tape are attached, wherein:
the cut second tapes comprise a 2-1 tape attached to the first divided electrode plate and a 2-2 tape attached to the second divided electrode plate, and the 2-1 tape and the 2-2 tape extend to cover at least a portion of one side surface of the coating layer while covering outer surfaces of the 1-1 tape and the 1-2 tape, respectively.

14. The method as claimed in claim 13, wherein the first cutting line is set to a position approximately the same as a position of the second cutting line.

15. The method as claimed in claim 13, wherein:
the second base material tape is attached to protrude from a lower surface of each of the first divided electrode plate and the second divided electrode plate; and
the 2-1 tape and the 2-2 tape extend longer than the 1-1 tape and the 1-2 tape, respectively, and cover at least a portion of a lower surface of the coating layer.

16. The method as claimed in claim 13, wherein:
the coating layer comprises a first coating layer formed on the front surface of the substrate and a second coating layer formed on the rear surface of the substrate; and
the first tape comprises a first front surface tape attached to the first coating layer and a first rear surface tape attached to the second coating layer.

17. The method as claimed in claim 16, wherein the second tape comprises a second front surface tape extending to cover the first front surface tape and a second rear surface tape extending to cover the first rear surface tape.

18. The method as claimed in claim 17, wherein an adhesive surface of the second front surface tape and an adhesive surface of the second rear surface tape are attached by coming into contact with one another.

19. The method as claimed in claim 17, wherein any one of the second front surface tape and the second rear surface tape extends to cover at least a portion of an outer surface of the other surface tape to overlap the other.

20. The method as claimed in claim 11, wherein:
the coating substrate is provided to correspond to an upper end portion and comprises an uncoated portion, which is an area in which the coating layer is not formed; and
the first tape and the second tape are not located in the uncoated portion.
